(19) United States
(12) Patent Application Publication
(10) Pub. No.: US 2005/0010928 A1
(43) Pub. Date: Jan. 13, 2005

(54) Service device and method for spontaneously providing status notification

(76) Inventor: Nobuhiro Gunji, Nagano-ken (JP)

Correspondence Address: MARTINE & PENILLA, LLP, 710 LAKEWAY DRIVE, SUITE 170, SUNNYVALE, CA, 94085, US

(21) Appl. No.: 10/828,909

(22) Filed: Apr. 20, 2004

(30) Foreign Application Priority Data
Apr. 24, 2003 (JP) 2003-119494
Mar. 12, 2004 (JP) 2004-69957

(51) Int. Cl. G06F 9/44

(52) U.S. Cl. 719/318

(57) ABSTRACT

The present invention provides a technique of enabling a user of a client to readily recognize whether or not a service device is capable of providing a service. The service device is connected to the client via a network and sequentially provides a service in response to a service request from the client. The service device comprises: a detection module that detects whether or not the service device is capable of providing a service within a preset time period; and a notification module that notifies the client of the result of detection regardless of whether or not the service request has been issued from the client.

### BACKGROUND OF THE INVENTION 1. Field of the Invention

The present invention relates to a service device that spontaneously provides a status notification. 2.Description of the Related Art

A service device such as a printing device or a scanner is connected to a client via a network such as a LAN (Local Area Network) and provide a service in response to a service request from the client.

A printing device, for example, obtains a service request from a client in a format of print job data. When the printing device receives a plurality of print jobs, the printing device processes and executes the plurality of print jobs in a sequential way.

The client can receive a status notification that indicates termination of a process according to a print job, or insufficiency of paper or ink from the printing device. The client can also receive a status notification that indicates job congestion from the printing device.

However, it has been difficult for a user of the client to readily recognize whether or not a service device is capable of providing a service in real time. The problem arises because the user of the client needs to ask the service device to issue a status notification in order to recognize whether or not the service device is capable of providing a service in real time.

### SUMMARY OF THE INVENTION

The object of the present invention is thus to provide a technique of enabling a user of a client to readily recognize whether or not a service device is capable of providing a service.

In order to attain at least part of the above object, the present invention provides a first apparatus i.e. a service device that sequentially provides a service in response to a service request from a client. The client is connected to the service device via a network. The service device comprises: a detection module that detects whether or not the service device is capable of providing a service within a preset time period; and a notification module that notifies the client of the result of detection regardless of whether or not the service request has been received from the client.

The service device notifies the client of the result of the detection, which relates to whether or not the service device is capable of providing a service within the preset time period, regardless of whether or not the service request has been received from the client. Thus, a user of the client can readily recognize whether or not the service device is capable of providing a service.

The “preset time period” may be a fixed period of time (constant period of time) or may alternatively be a period of time that is separately determined for each client.

In the above apparatus, it is preferable that the notification module notifies the client of the result of detection when a change is detected between a state in which the service device is capable of providing a service within the preset time period and a state in which the service device is incapable of providing a service within the preset time period.

This arrangement lowers a frequency at which the service device notifies the client of the result of detection and thereby advantageously reduces a traffic volume in the network.

It should be noted that the result of detection may be notified only when the service device became capable of providing a service within the preset time period or only when the service device became incapable of providing a service within the preset time period, or may be notified in both cases.

In the above apparatus, the detection module may detect whether or not the service device is capable of providing a service in real time.

In the above apparatus, it is preferable that the service device further comprises: a setting module that registers the client as a target of notification, wherein the notification module notifies the registered client of the result of detection.

In this arrangement, a restricted member of clients are allowed to become the target of notification, so that the traffic volume in the network and the load on clients that are not subjected to notification can be reduced.

In the above apparatus, the service device may further comprises: a reception module that receives information from the client, the information relating to an attribute or type of a service required by the client, wherein the setting module registers the client if the service device is capable of providing a service of the attribute or type.

In this arrangement, the client can selectively receive a notification from the service device that is capable of providing a service of the desired attribute or type.

In the above apparatus, the setting module may register a plurality of the clients and store a use condition in connection with a specific client of the plurality of clients, the use condition being used for allowing the specific client to use the service device preferentially. When the use condition is satisfied, the notification module may further notify the specific client of the satisfaction of the use condition.

In this arrangement, the client is allowed to have priority use of the service device.

In the above apparatus, when the use condition is satisfied, the notification module may further notify a client other than the specific client that the service device became incapable of providing a service.

In this arrangement, no client other than the specific client is required to issue a service request to the service device that is incapable of providing a service.

The present invention also provides a second apparatus i.e. a client that issues a service request to a service device via a network. The service device sequentially provides a service. The client comprises: a receive module that receives a result of detection from the service device regardless of whether or not the service request has been issued to the service device, the result of detection relating to whether or not the service device is capable of providing a service within a preset time period; and an acquaint module that acquaints a user of the client with the result of detection regardless of whether or not the service request has been issued to the service device.

The client receives the result of detection, which relates to whether or not the service device is capable of providing a service within the preset time period, from the service device, regardless of whether or not the service request has been issued to the service device. Thus, a user of the client can readily recognize whether or not the service device is capable of providing a service.

In the above apparatus, the client may further comprise: a transmit module that transmits registration information to the service device, the registration information being used for registering the client at the service device, so that the client receives the result of detection from the service device.

In this arrangement, the client can receive a notification that is based on the registration information from the service device.

It should be noted that the registration information may include information for identifying the client such as an address or name. Alternatively, the registration information may include information representing an attribute or type of a service required by the client.

The present invention also provides a method, in a service system including a service device that sequentially provides a service and a client that issues a service request to the service device via a network, for acquainting a user of the client with information regarding the service device. The method comprises the steps of (a) the service device detecting whether or not the service device is capable of providing a service within a preset time period; (b) the service device notifying the client of the result of detection, regardless of whether or not the service request has been issued from the client to the service device; and (c) the client acquainting the user with the result of detection, regardless of whether or not the service request has been issued from the client to the service device.

In this method, the client receives the result of detection, which relates to whether or not the service device is capable of providing a service within the preset time period, from the service device regardless of whether or not the service request has been issued to the service device. Thus, the user of the client can readily recognize whether or not the service device is capable of providing a service.

It should be noted that the present invention may be actualized by a diversity of applications such as a service device and a method of controlling the same, a client and a method of controlling the same, a service system including a service device and a client and a method of controlling the same, computer programs that attain these methods or functions of devices, recording media in which such computer programs are recorded, and data signals that include such computer programs and are embodied in carrier waves.

Typical examples of the “recording media” of the present invention include flexible disks, CD-ROMs, magneto-optic discs, IC cards, ROM cartridges, punched cards, prints with barcodes or other codes printed thereon, and internal storage devices (memories like a RAM and a ROM) and external storage devices of the computer, and a variety of other computer readable media.

These and other objects, features, aspects, and advantages of the present invention will become more apparent from the following detailed description of the preferred embodiments with the accompanying drawings.

### BRIEF DESCRIPTION OF THE DRAWINGS

FIG. 1 is a schematic illustrating a print processing system 1000;

FIG. 2 is a flowchart showing a process of notification transmission and a process of notification reception;

FIG. 3 is schematic illustrating one example of a pop-up window (user interface screen) that is displayed in step Sb3 of FIG. 3;

FIG. 4 is a schematic illustrating one example of a list displaying window (user interface screen);

FIG. 5 is a flowchart showing a series of notification process;

FIG. 6 is a schematic showing pieces of reservation information that is stored in a setting module 112;

FIG. 7 is a flowchart showing a process that is based on the reservation information; and

FIG. 8 is a flowchart showing a process of determining a client to become a target of notification.

### DESCRIPTION OF THE PREFERRED EMBODIMENTS

Some modes of carrying out the invention are discussed below as embodiments in the following order:
A. Configuration of Print Processing System;
B. Notification Process; and
C. Process based on Reservation Information.

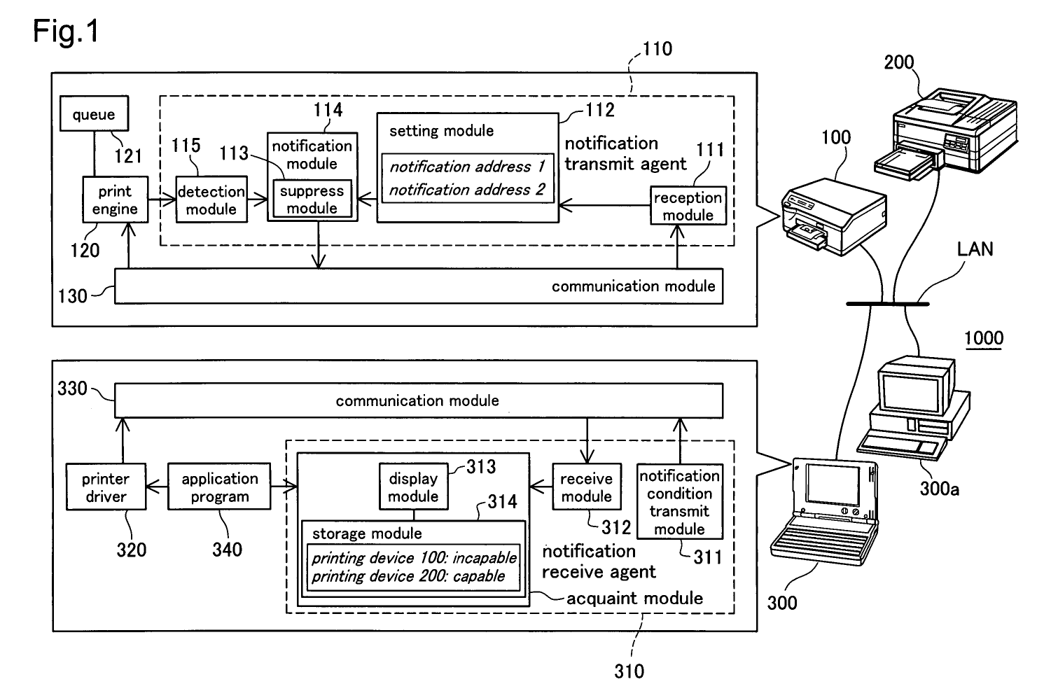

A. Configuration of Print Processing System: FIG. 1 is a schematic illustrating a print processing system 1000. The print processing system 1000 comprises two printing devices (service devices) 100, 200 and two clients 300, 300a that are connected together via a network NW.

For convenience of explanation, the following describes the present invention mainly with a focus on the printing device 100 and the client 300.

The printing device 100 provides a print service in response to a service request from each of the clients 300, 300a. Examples of the printing device 100 include inkjet printers, laser printers, and other various types of printers.

The client 300 transmits a request for print service (a service request) to the printing devices 100, 200 in a format of print job data.

In FIG. 1, functional blocks of the printing device 100 and the client 300 are illustrated. The printing device 100 and the client 300 respectively have computers embedded therein. Each computer includes a CPU, a ROM, and a RAM not shown. The embedded computers execute certain processing programs to attain functions of the blocks in the printing device 100 and functions of the blocks in the client 300, respectively. Some or all of the functions of the blocks in the printing device 100 and/or some or all of the functions of the blocks in the client 300 may be configured by hardware. The printing device 200 functions similarly as the printing device 100 and the client 300a functions similarly as the client 300.

The client 300 includes a communication module 330, an application program 340, a printer driver 320, and a notification receive agent 310. The communication module 330 can communicate with the printing devices 100, 200 via the network NW.

The application program 340 is a program which is capable of utilizing a print service of the printing device 100. Examples of such a program include word processor, web browser, spreadsheet software, graphics drawing software, and the like. The printer driver 320 generates a print job based on an instruction from the application program 340. The communication module 330 transmits the print job to the printing device 100 via the network NW.

The notification receive agent 310 includes a receive module 312, an acquaint module including a display module 313 and a storage module 314, and a notification condition transmit module 311.

The receive module 312 receives, from each of the printing devices 100 and 200, a notification that indicates whether or not the printing device is capable of providing a service in real time.

The acquaint module acquaints a user with information based on the notification from each of the printing devices 100, 200. In the present embodiment, the acquaint module causes the display module 313 to display a pop-up window so as to acquaint the user with information. In the present embodiment, however, the acquaint module causes the display module 313 to display a pop-up window only when the application program 340 is running and does not cause the display module 313 to display a pop-up window when the application programs 340 is not running.

Based on the notification from each of the printing devices 100, 200, the acquaint module causes the storage module 314 to store information that pertains to whether or not the printing device is capable of providing a service in real time.

The notification condition transmit module 311 transmits an address of the client 300 (or an address of itself) to the printing devices 100, 200. This enables the client 300 to receive the notifications described above. The notification condition transmit module 311 also transmits reservation information for reserving a use of printing device (information that pertains to a period to be reserved or to a period expected for use) to each of the printing devices 100, 200. This enables the client 300 to receive a print service of the printing device preferentially during the reserved time period. In other words, the client can receive the print service within a short period of time after the service request was issued.

The printing device 100 includes a communication module 130, a print engine 120, a print queue 121, and a notification transmit agent 110. The communication module 130 can communicate with the clients 300, 300a via the network NW.

The print engine 120 processes print jobs that are respectively provided from the printer drivers 320 of the clients 300, 300a via the communication module 130 and prepares for printing. The print engine 120 also stores the print jobs into the print queue 121. In case where a plurality of jobs arrive at the printing device 100 within a certain period of time, the plurality of jobs form a queue. The print engine 120 sequentially processes the jobs in the order of arrival.

The notification transmit agent 110 includes a reception module 111, a setting module 112, a detection module 115, and a communication module 114.

The reception module 111 obtains the notification conditions (registration information) that are respectively transmitted from the notification condition transmit modules 311 of the clients 300, 300a.

The setting module 112 includes a memory, and stores the obtained notification conditions into the memory. In the present embodiment, the addresses and reservation information of the clients 300, 300a are recorded in the setting module 112.

The detection module 115 monitors the print queue 121 via the print engine 120 and detects a change of state of the printing device 100, or in other words, detects whether or not the printing device 100 is capable of providing a print service in real time. If no print job is in the queue 121, the printing device 100 is capable of providing a print service in real time. If some print job is in the queue 12, the printing device 100 is incapable of providing a print service in real time. Note that the printing device 100 is also incapable of providing a print service in real time, if an error occurs due to e.g. paper jam or if a consumable such as paper or ink is insufficient.

The communication module 114 provides a notification to the clients 300, 300a that correspond to the addresses recorded in the setting module 112, based on the result of detection by the detection module 115. Specifically, the communication module 114 notifies the clients 300, 300a of the result of detection when the state of the printing device is changed, in other words, when the printing device became capable of providing a print service in real time or when the printing device became incapable of providing a print service in real time.

The communication module 114 also provides a notification to the clients 300, 300a that correspond to the addresses recorded in the setting module 112, based on the reservation information (the reserved time period) recorded in the setting module 112. Specifically, at a start time of the reserved time period, the communication module 114 notifies the client, which registered the reservation information, of the reserved time period having come. During the reserved time period, the communication module 114 suppresses notifications to the clients other than the one that registered the reservation information. The notifications to be suppressed include, for example, a notification of the printing device being capable of providing a print service in real time. The function of suppressing is attained by a suppress module 113 provided in the communication module 114.

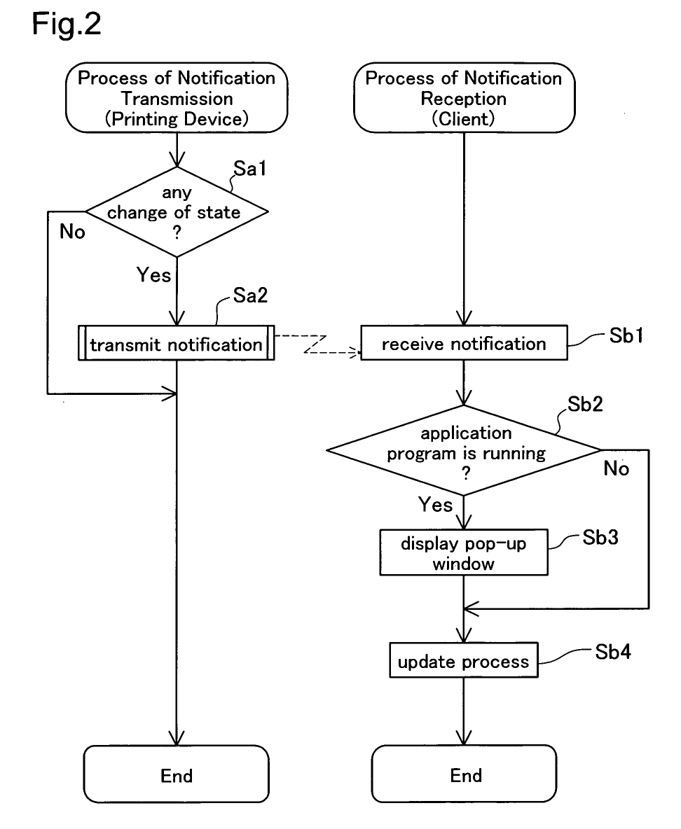

B. Notification Process: FIG. 2 is a flowchart showing a process of notification transmission and a process of notification reception. The printing device 100 repeatedly executes “the process of notification transmission” shown in FIG. 2, whereas the client 300 repeatedly executes “the process of notification reception” shown in FIG. 2.

In step Sa1 of the process of notification transmission, the detection module 115 of the printing device 100 detects a change of state of the printing device. Specifically, the detection module 115 detects a change between a state in which the printing device 100 is capable of providing a print service in real time and a state in which the printing device 100 is incapable of providing a print service in real time. Process of step Sa2 is then executed when the change of the state is detected, or in other words, when the printing device 100 became capable of providing a print service in real time or when the printing device 100 became incapable of providing a print service in real time.

In step Sa2, the communication module 114 provides a notification to each of the clients 300, 300a. Specifically, the communication module 114 provides a notification to each of the clients, informing that the printing device 100 became capable of providing a print service in real time or that the printing device 100 became incapable of providing a print service in real time. It should be noted that the notification is provided to each of the clients that correspond to the addresses stored in the setting module 112.

In step Sb1 of the process of notification reception, the receive module 312 of the client 300 receives the notification described above. In step Sb2, the acquaint module determines whether or not the application program 340 is running. If the application program 340 is running, the acquaint module in step Sb3 causes the display module 313 to display a pop-up window so as to acquaint the user with information. This enables the user to readily recognize whether or not the printing device 100 is capable of providing a print service in real time. In step Sb4, the acquaint module causes the storage module 314 to update its stored contents. Specifically, the storage module 314 updates its stored contents with respect to whether or not the printing device 100, which is the source of communication, is capable of providing a print service in real time.

In the present embodiment, the pop-up window is displayed if an application program which is capable of utilizing print services of the printing device 100 is running. The pop-up window, however, may alternatively be displayed only if an application program which is previously selected by the user is running.

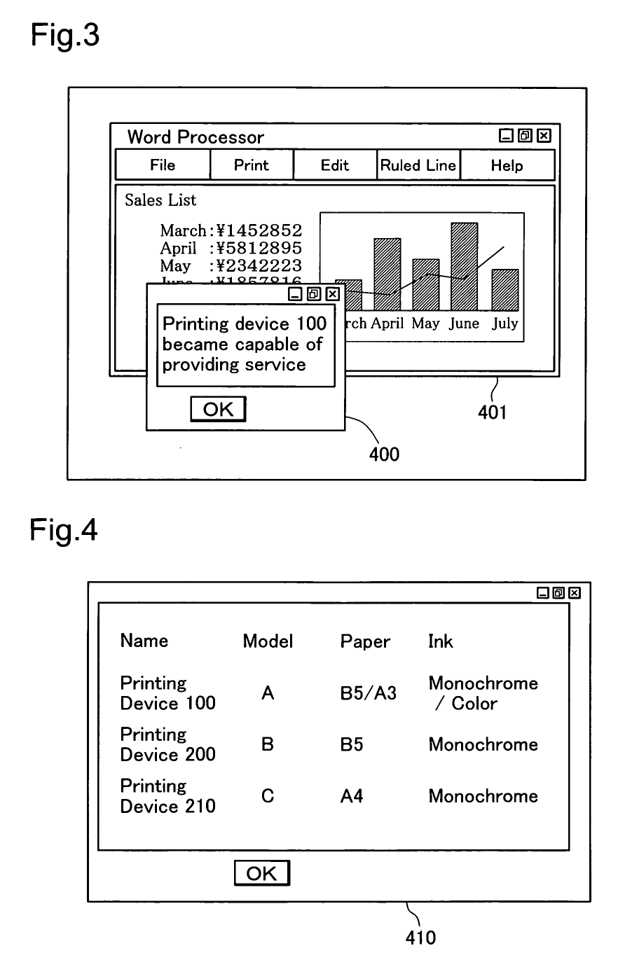

FIG. 3 is a schematic illustrating one example of the pop-up window (user interface screen) that is displayed in step Sb3 of FIG. 3. In FIG. 3, a word processor is running and a window 401 of the word processor is displayed. In this case, it is determined that the application program 340 is running in step Sb2 (FIG. 2) and a pop-up window 400 is displayed in step Sb3. The pop-up window is displayed independently of the user operation.

The pop-up window 400 of FIG. 3 indicates that the printing device 100 became capable of providing a print service. A pop-up window is similarly displayed when the printing device 100 became incapable of providing a print service.

By the way, in the present embodiment, the acquaint module causes the storage module 314 to update its stored contents in step Sb4 of FIG. 2. The acquaint module is thus allowed to cause the display module 313 to display a list displaying window at any timing according to an instruction from the user.

FIG. 4 is a schematic illustrating one example of the list displaying window (user interface screen). The list displaying window 410 displays a list of printing devices that are capable of providing print services in real time. The acquaint module causes the display module 313 to display the list displaying window 410 only based on the stored contents of the storage module 314, in other words, without the need of asking each of the printing devices to notify its status.

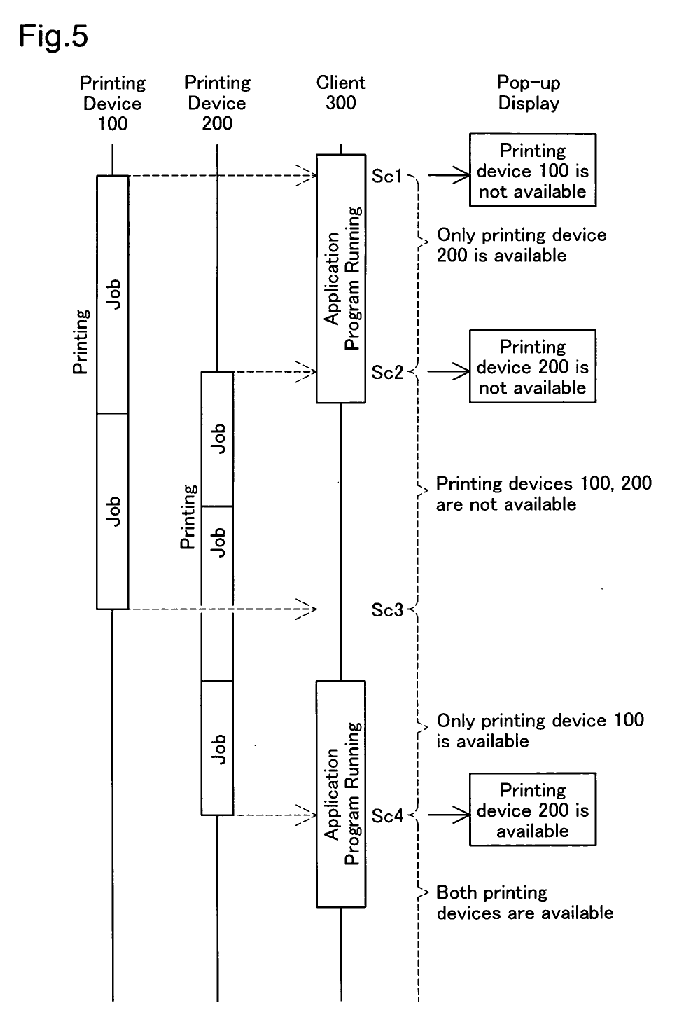

FIG. 5 is a flowchart showing a series of notification process. The printing device 100 processes two print jobs in a period from Sc1 to Sc3, whereas the printing device 200 processes three print jobs in a period from Sc2 to Sc4. Namely, the printing device 100 is incapable of providing a service in real time in the period from Sc1 to Sc3, whereas the printing device 200 is incapable of providing a service in real time in the period from Sc2 to Sc4.

The printing device 100 notifies the client 300 of its becoming incapable of providing a service in real time at time Sc1 and of its becoming capable of providing a service in real time at time Sc3. Similarly, the printing device 200 notifies the client 300 of its becoming incapable of providing a service in real time at time Sc2 and of its becoming capable of providing a service in real time at time Sc4.

The client 300 displays a pop-up window in response to the notification that was received at time Sc1, Sc2, and Sc4 (step Sb3 of FIG. 2). Although the notification was also received at time Sc3, the client 300 does not display a pop-up window at this time, since it is determined that the application program 340 is not running at time Sc3 (step Sb2 of FIG. 2).

The client 300 also updates the stored contents in response to the notification that was received at time Sc1, Sc2, Sc3, and Sc4 (step Sb4 of FIG. 2). This enables the user to be notified at desired timings of which printing device(s) is capable of providing a service in real time, from the list displaying window 410 of FIG. 4. For example, the user can be notified of only the printing device 200 is capable of providing a service in real time in a period from Sc1 to Sc2; both the printing devices 100, 200 are incapable of providing services in real time in a period from Sc2 to Sc3; only the printing device 100 is capable of providing a service in real time in a period from Sc3 to Sc4; and both the printing devices 100, 200 are capable of providing services in real time at time Sc4 or later.

As described above, in the print processing system of the present embodiment, the printing device spontaneously provides a status notification to the client. This enables the client to readily recognize whether or not the printing device is capable of providing a service in real time without the need of asking the printing device to issue a status notification. It is particularly advantageous in case where a plurality of printing devices are connected to the network, since the user can readily find out which printing device(s) among the plurality of printing devices is capable of providing a service in real time.

The arrangement of the present embodiment is advantageous in that it can reduce the load on the client, printing device, and network. In the prior art, for example, the client needs to ask the printing device to issue a status notification for a number of times until job congestion is resolved or paper or ink is refilled. The client also needs to ask a plurality of printing devices to issue status notifications in order to find out which printing device(s) among the plurality of printing devices is capable of providing a service in real time. This results in generation of a large number of requests for status notifications, which increases the load on the client and lowers communication efficiency in the network. In the present embodiment, however, the printing device spontaneously issues a status notification, which advantageously reduces the load on the client, printing device, and network.

The arrangement of the present embodiment is also advantageous in that the load can be shared among a plurality of printing devices. In the prior art, even a printing device that is incapable of providing a print service in real time often receives a print job. This results in uneven frequency of service provisions among the plurality of printing devices. In the present embodiment, however, the user of the client can readily recognize the states of the plurality of printing devices and can readily select a printing device that is capable of providing a print service in real time. This prevents some printing devices to have notably higher operating rates and thereby allows for sharing of load among the plurality of printing devices.

It should be noted that the notification that is transmitted from the printing device in step Sa 2 of FIG. 2 not only include information that indicates whether or not the printing device is capable of providing a print service in real time, but may also include a variety of other information. The notification, for example, may include information that indicates a size of paper that is available in the printing device, whether or not color printing is available, whether or not duplex printing is available, or the like. By having the printing device notifying the client of information that pertains to an attribute or type of an available service (or information that pertains to a servicing capability of the printing device), the acquaint module of the client can cause the display module to display the information. This enables the user of the client to readily select a printing device that is capable of providing a service of the desired attribute or type. The list displaying window of FIG. 4 shows information for identification such as a name or model of each printing device as well as information such as a size of paper or type of ink that are available in each printing device (or information that pertains to whether the service is color printing or monochrome printing). The list displaying window may also show other information such as a cost of printing and a time at which a notification that a print service is available in real time is received from the printing device, in connection with each printing device.

C. Process based on Reservation Information: The following describes a process that is executed when a use of a printing device was reserved. As described above, the client 300 transmits the reservation information to the printing device 100, which stores the reservation information in the setting module 112.

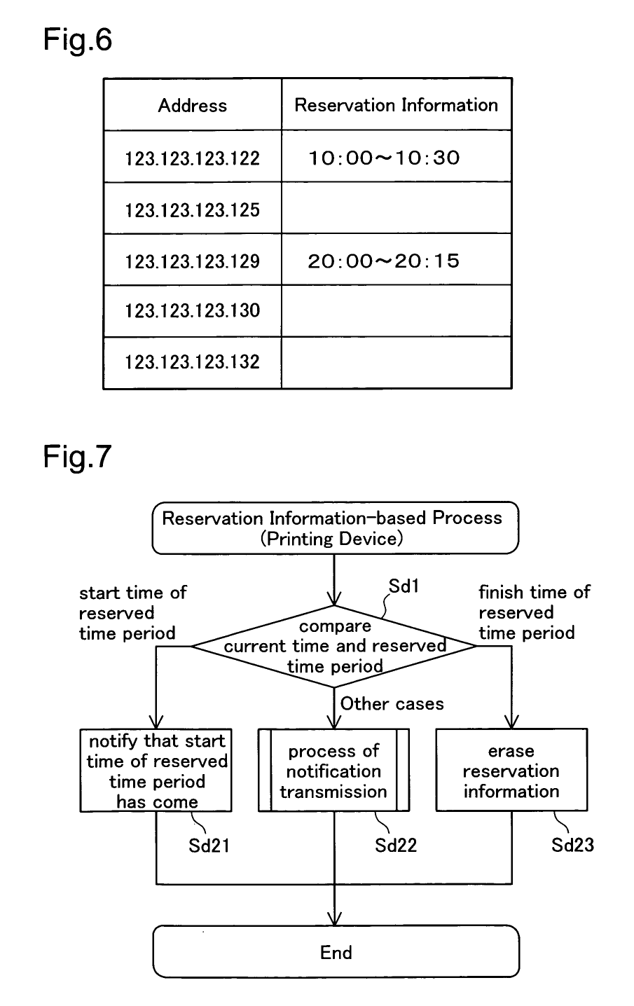

FIG. 6 is a schematic showing the reservation information that is stored in the setting module 112. As shown, the setting module 112 stores the reservation information in connection with an address of the client or the target of notification. In the example of FIG. 6, five addresses are stored and two of them have the reservation information (reserved time periods) associated therewith.

FIG. 7 is a flowchart showing a process that is based on the reservation information. The printing device 100 repeatedly executes the process shown in FIG. 7.

In step Sd1, the communication module 114 compares a current time and the reserved time period stored in the setting module 112.

If the current time coincides with a start time of the reserved time period, the communication module 114 in step Sd21 provides a notification to the client that registered the reservation information (or the client that reserved a use of the printing device 100), informing that the start time of the reserved time period has come. In this case, the client that registered the reservation information receives the notification and displays a pop-up window, indicating that the start time of the reserve time period has come, as in the process of notification reception of FIG. 2. In step Sd21, the communication module 114 also provides notifications to the clients other than the one that registered the reservation information, informing that the printing device 100 became incapable of providing a service. In this case, each of the other clients receives the notification and displays a pop-up window, indicating that the printing device 100 became incapable of providing a service, as in the process of notification reception of FIG. 2.

If the current time coincides with a finish time of the reserved time period, the communication module 114 in step Sd23 erases the reservation information stored in the setting module 112. The communication module 114 then provides notifications to the clients other than the one that registered the reservation information, informing that the printing device 100 became capable of providing a service.

Otherwise, or if the current time coincides with neither the start time nor the finish time of the reservation time period, the communication module 114 in step Sd22 executes the process of notification transmission as described with reference to FIG. 2. It should be noted, however, that the client or the target of notification is changed based on the relationship between the current time and the reservation time period as follows.

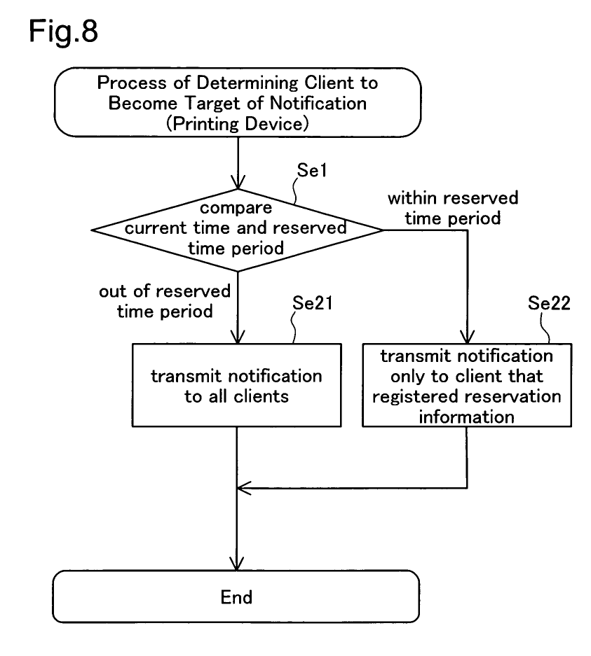

FIG. 8 is a flowchart showing a process of determining the client to become the target of notification. In step Se1, the communication module 114 compares the current time and the reserved time period stored in the setting module 112. Specifically, the communication module 114 checks if the current time is within or out of the reserved time period stored in the setting module 112.

If the current time is out of the reserved time period, the communication module 114 in step Se21 determines all of the clients corresponding to the addresses stored in the setting module 112 to be the target of notification and executes the process of notification transmission similar to FIG. 2. On the other hand, if the current time is within the reserved time period, the communication module 114 in step Se22 determines only the client that registered the reservation information to be the target of notification and executes the process of notification transmission similar to FIG. 2.

As described above, in the print processing system of the present embodiment, the printing device stores the reserved time period (use condition) in which the client is allowed to use the printing device preferentially, in connection with the client information, and thereby notifies the client of arrival of the start time of the reservation time period. This enables the client to have priority use of the printing device in the reserved time period.

The reservation information is not restricted to a reserved time period in future, but may also be a reserved time period that starts right now. In this case, the client can also use the printing device preferentially. Alternatively, the setting module 112 may only store a time to start using the printing device but not a time to finish using the same. In such a case, the printing device may terminate the state of priority use according to another instruction from the client or after a certain period of time.

The above embodiment and its modifications are to be considered in all aspects as illustrative and not restrictive. There may be many modifications, changes, and alterations without departing from the scope or spirit of the main characteristics of the present invention. For example, the following modifications are possible.

(1) In the above embodiment, printing devices are used as service devices, but instead of this, or in addition to this, other devices may be used as service devices. For example, scanners, projectors, audio devices, and a variety of other devices that can only process one job at a time may be used. In general, a service device may be any device which can sequentially provide a service in response to a service request from a client.

(2) Although two service devices (printing devices) are connected to the network NW in the above embodiment, the number of connected service devices may alternatively be larger or smaller. Additionally, although two clients are connected to the network NW in the above embodiment, the number of connected clients may alternatively be larger or smaller. In general, at least one service device and at least one client will be connected to a network.

The network NW may be a limited type of network such as personal computer communication or local area network, or may alternatively be a wide area network such as Internet. The network NW may alternatively be a network that communicates through wireless communication.

(3) In the above embodiment, the notification condition transmit module 311 of the client 300 transmits an address and reservation information as a notification condition to each of the printing devices 100, 200. The notification condition transmit module 311, however, may alternatively transmit other information such as information that pertains to an attribute or type of a print service required by the client 300. Examples of such information include: whether the service is color printing or monochrome printing, a type of printing paper (e.g. a size of printing paper), a speed of printing, a quality level of printing, whether the service is one-side printing or two-side printing.

In such a case, the reception module 111 of each of the printing devices 100, 200 receives the attribute or type of the print service required by the client 300. If the printing device 100 or 200 is capable of providing the service of the required attribute or type, the setting module 112 of the printing device 100 or 200 registers the client 300 as the target of notification. This enables the client 300 to selectively receive a notification from the printing device that is capable of providing the service of the desired attribute or type.

(4) In the above embodiment, the printing device notifies the client of whether or not it is capable of providing a service in real time, but the printing device may instead notify the client of whether or not it is capable of providing a service within a preset time period. The preset time period may be a fixed period of time (a constant period of time), or may alternatively be a variable period of time that is separately determined for each client. If the preset time period is a constant period of time, the printing device may have the constant period of time set in advance. If the preset time period is a variable period of time that is separately determined for each client, the notification condition transmit module 311 of each of the clients 300, 300a may transmit time period information, which is then stored by the setting module 112 of the printing device 100 in connection with the client. In such a case, the printing device may notify the client of its becoming capable of providing a print service within a preset time period, at the time that is earlier than the time Sc3 for the preset time period, for example in FIG. 5.

(5) In step Sa2 of FIG. 2, the client or the target of notification is determined through the process of the client transmitting its address to the printing device and of the printing device registering the address therein. The target of notification, however, may alternatively be determined through other processes.

For example, the notification may be provided to the clients in a preset range through the process of multicast or broadcast. The clients in the preset range may be clients that belong to a preset hierarchy of a hierarchical network, or may alternatively be clients that are located on a preset floor. In such a case, the setting module 112 may store a range of addresses, a domain, or a so-called network number that correspond to the preset range. If the network is a wireless network in a so-called hot spot, the notification may be provided to the every client in the hot spot.

Setting the clients within the preset range as the target of notification enables each of the clients to receive the notification from the service device without the need of transmitting its address to the service device.

(6) In the above embodiment (step Sa2 of FIG. 2), the communication module notifies the client of the state of the printing device when any variation is detected in the state of the printing device. The communication module, however, may alternatively notify the client of the state of the printing device at preset time intervals. It should be noted, however, that the arrangement of the above embodiment is advantageous in that it can lower the frequency at which the service device notifies the client of the result of detection and thereby reduce the traffic volume in the network.

In general, the service device will detect whether or not the service device is capable of providing a service within a preset time period and notify the client of the result of detection (the state of the service device), regardless of whether or not the service request has been issued from the client.

Although the present invention has been described and illustrated in detail, it is clearly understood that the same is by way of illustration and example only and is not to be taken by way of limitation, the spirit and scope of the present invention being limited only by the terms of the appended claims.

1. A service device that sequentially provides a service in response to a service request from a client, the client being connected to the service device via a network, the service device comprising:
a detection module that detects whether or not the service device is capable of providing a service within a preset time period; and
a notification module that notifies the client of the result of detection regardless of whether or not the service request has been received from the client.

2. The service device in accordance with claim 1, wherein
the notification module notifies the client of the result of detection when a change is detected between a state in which the service device is capable of providing a service within the preset time period and a state in which the service device is incapable of providing a service within the preset time period.

3. The service device in accordance with claim 1, wherein
the detection module detects whether or not the service device is capable of providing a service in real time.

4. The service device in accordance with claim 1, further comprising:
a setting module that registers the client as a target of notification,
wherein the notification module notifies the registered client of the result of detection.

5. The service device in accordance with claim 4, further comprising:
a reception module that receives information from the client, the information relating to an attribute or type of a service required by the client,
wherein the setting module registers the client if the service device is capable of providing a service of the attribute or type.

6. The service device in accordance with claim 4, wherein
the setting module is capable of registering a plurality of the clients;
the setting module stores a use condition in connection with a specific client of the plurality of clients, the use condition being used for allowing the specific client to use the service device preferentially; and
when the use condition satisfied, the notification module further notifies the specific client of the satisfaction of the use condition.

7. The service device in accordance with claim 6, wherein
when the use condition satisfied, the notification module further notifies a client other than the specific client that the service device became incapable of providing a service.

8. A method in a service device that sequentially provides a service in response to a service request from a client, the client being connected to the service device via a network, the method comprising the steps of:
detecting whether or not the service device is capable of providing a service within a preset time period; and
notifying the client of the result of detection regardless of whether or not the service request has been received from the client.

9. The method in accordance with claim 8, wherein
the notifying step includes:
notifying the client of the result of detection when a change is detected between a state in which the service device is capable of providing a service within the preset time period and a state in which the service device is incapable of providing a service within the preset time period.

10. The method in accordance with claim 8, wherein
the detecting step includes:
detecting whether or not the service device is capable of providing a service in real time.

11. The method in accordance with claim 8, further comprising:
registering the client as a target of notification,
wherein the notifying step includes:
notifying the registered client of the result of detection.

12. The method in accordance with claim 11, further comprising:
receiving information from the client, the information relating to an attribute or type of a service required by the client,
wherein the registering step includes:
registering the client if the service device is capable of providing a service of the attribute or type.

13. The method in accordance with claim 11, wherein
the registering step includes:
registering a plurality of the clients; and
registering a use condition in connection with a specific client of the plurality of clients, the use condition being used for allowing the specific client to use the service device preferentially, and
the method further comprises:
when the use condition satisfied, notifying the specific client of the satisfaction of the use condition.

14. The method in accordance with claim 13, further comprising:
when the use condition satisfied, notifying a client other than the specific client that the service device became incapable of providing a service.

15. A client that issues a service request to a service device via a network, the service device sequentially providing a service, the client comprising:
a receive module that receives a result of detection from the service device regardless of whether or not the service request has been issued to the service device, the result of detection relating to whether or not the service device is capable of providing a service within a preset time period; and
an acquaint module that acquaints a user of the client with the result of detection regardless of whether or not the service request has been issued to the service device.

16. The client in accordance with claim 15, further comprising:
a transmit module that transmits registration information to the service device, the registration information being used for registering the client at the service device, so that the client receives the result of detection from the service device.

17. A method, in a service system including a service device that sequentially provides a service and a client that issues a service request to the service device via a network, for acquainting a user of the client with information regarding the service device, the method comprising the steps of
(a) the service device detecting whether or not the service device is capable of providing a service within a preset time period;
(b) the service device notifying the client of the result of detection, regardless of whether or not the service request has been issued from the client to the service device; and
(c) the client acquainting the user with the result of detection, regardless of whether or not the service request has been issued from the client to the service device.

18. A computer program product for causing a service device to notify a client of information, the service device sequentially providing a service in response to a service request from the client, the client being connected to the service device via a network, the computer program product comprising:
a computer readable recording medium; and
a computer program stored on the computer readable recording medium,
the computer program causing the service device to attain the functions of:
detecting whether or not the service device is capable of providing a service within a preset time period; and
notifying the client of the result of detection, regardless of whether or not the service request has been received from the client.

19. A computer program product for causing a client to receive information from a service device, the client issuing a service request to the service device via a network, the service device sequentially providing a service, the computer program product comprising:
a computer readable recording medium; and
a computer program stored on the computer readable recording medium,
the computer program causing the client to attain the functions of
receiving a result of detection from the service device regardless of whether or not the service request has been issued to the service device, the result of detection relating to whether or not the service device is capable of providing a service within a preset time period; and
acquainting a user of the client with the result of detection, regardless of whether or not the service request has been issued to the service device.
